(19) United States
(12) Patent Application Publication
(10) Pub. No.: US 2014/0027370 A1
(43) Pub. Date: Jan. 30, 2014

(54) SEPARATION MEMBRANE MODULE AND COUPLING MEMBER

(71) Applicants: Kentarou Kobayashi, Osaka (JP); Takahisa Konishi, Osaka (JP); Makoto Kobuke, Osaka (JP)

(72) Inventors: Kentarou Kobayashi, Osaka (JP); Takahisa Konishi, Osaka (JP); Makoto Kobuke, Osaka (JP)

(73) Assignee: NITTO DENKO CORPORATION, Ibaraki-shi, Osaka (JP)

(21) Appl. No.: 14/110,032

(22) PCT Filed: Apr. 4, 2012
(86) PCT No.: PCT/JP2012/002364

§ 371 Date: Oct. 4, 2013

(30) Foreign Application Priority Data
Apr. 6, 2011 (JP) 2011-084563

(51) Int. Cl. B01D 63/12; F16L 21/02

(52) U.S. Cl. CPC B01D 63/12; F16L 21/02
USPC 210/321.83; 285/352; 210/321.87

(57) ABSTRACT

A separation membrane module includes: a pressure container having a tubular shape; a plurality of separation membrane elements loaded in the pressure container so as to be aligned in the axial direction of the pressure container; and a coupling member coupling together the separation membrane elements adjacent to each other. The separation membrane element includes a central tube and a pair of end members 3A and 3B fixed to both end portions of the central tube. The coupling member 5A is configured to be engaged with at least one of the end members 3A and 3B located on both sides of the coupling member 5A. In addition, a sensor is mounted in the coupling member 5A.

### TECHNICAL FIELD

The present invention relates to a separation membrane module for producing a permeate liquid from a raw liquid, and to a coupling member used in the separation membrane module.

### BACKGROUND ART

Separation membrane modules used for, for example, seawater desalination and ultrapure water production, are conventionally known. For example, Patent Literature 1 discloses a separation membrane module 10 as shown in FIG. 8. In the separation membrane module 10, a plurality of spiral separation membrane elements 12 are loaded in a tubular pressure container 11 so as to be arranged in a line. As indicated by arrows in FIG. 8, when a raw liquid is fed into the pressure container 11 from one end of the separation membrane module 10, the raw liquid is filtered through the separation membranes of the spiral separation membrane elements 12 to produce a permeate liquid, and the permeate liquid and the concentrated raw liquid are separately discharged from the other end of the separation membrane module 10.

The spiral separation membrane elements 12 adjacent to each other are coupled by coupling members 15. Each spiral separation membrane element 12 has a configuration in which a layered body including separation membranes and flow path materials is wound around a central tube 13. Each coupling member 15 is generally a short tube both end portions of which are fitted to the central tubes 13 of the spiral separation membrane elements 12. In the example shown in FIG. 8, the coupling members 15 are fitted on the outer sides of the central tubes 13.

Furthermore, Patent Literature 1 describes providing the coupling member 15 with various sensors for detecting the characteristics of the raw liquid and the permeate liquid, and with an antenna for transmitting detection signals generated by the sensors. Since the separation membrane module 10 disclosed in Patent Literature 1 has such a configuration, the sensors and the like can be reused even when the spiral separation membrane elements 12 are replaced by new ones.

### CITATION LIST

### Patent Literature

Patent Literature 1: JP 2009-166034 A

### SUMMARY OF INVENTION

### Technical Problem

However, in the case where a sensor is provided, as described above, between spiral separation membrane elements by means of a coupling member (attaching member) or the like, the position of the sensor is not fixed since the coupling member can rotate relative to the spiral separation membrane elements. In the pressure container, the state of a flow of the raw liquid or the permeate liquid generally differs from region to region. Therefore, when the position of the sensor is not fixed, a situation may arise where values measured by the sensor vary, and reliable values cannot be obtained.

In view of such circumstances, the present invention aims to provide a separation membrane module that allows stable measurement using a sensor, and provide a coupling member suitably used in the separation membrane module.

### Solution to Problem

In order to solve the above problem, the present invention provides a separation membrane module including: a pressure container having a tubular shape; a plurality of separation membrane elements loaded in the pressure container so as to be aligned in an axial direction of the pressure container, each of the separation membrane elements including a central tube and a pair of end members fixed to both end portions of the central tube; a coupling member coupling together the separation membrane elements adjacent to each other by being fitted to the central tubes, the coupling member being configured to be engaged with at least one of the end members located on both sides of the coupling member; and a sensor mounted in the coupling member.

In addition, the present invention provides a coupling member for coupling together separation membrane elements each including a central tube and a pair of end members fixed to both end portions of the central tube, the coupling member including: an axial portion being hollow and having both end portions configured to be fitted in the central tubes; a plate portion configured to be interposed between the end members; and a projecting portion projecting from the plate portion and configured to be engaged with the end member.

### Advantageous Effects of Invention

In the separation membrane module of the present invention, the coupling member having the sensor mounted therein is restrained from rotating relative to the separation membrane elements. Therefore, stable measurement using the sensor can be performed.

### BRIEF DESCRIPTION OF DRAWINGS

FIG. 1 is a cross-sectional view of a separation membrane module according to a first embodiment of the present invention.

FIG. 2 is a schematic configuration diagram of a spiral separation membrane element that is an exemplary separation membrane element.

FIG. 3 is an exploded perspective view of a coupling member and end members located on both sides of the coupling member.

FIG. 4A is an elevation view of the coupling member, and FIG. 4B is a cross-sectional view taken along a IVB-IVB line of FIG. 4A.

FIG. 5A is a cross-sectional view taken along a VA-VA line of FIG. 1, and FIG. 5B is a cross-sectional view taken along a VB-VB line of FIG. 1.

FIG. 6 is a diagram illustrating the positional relationship between the end members located on both sides of the coupling member.

FIG. 7 is an elevation view of a coupling member of a second embodiment of the present invention.

FIG. 8 is a cross-sectional view of a conventional separation membrane module.

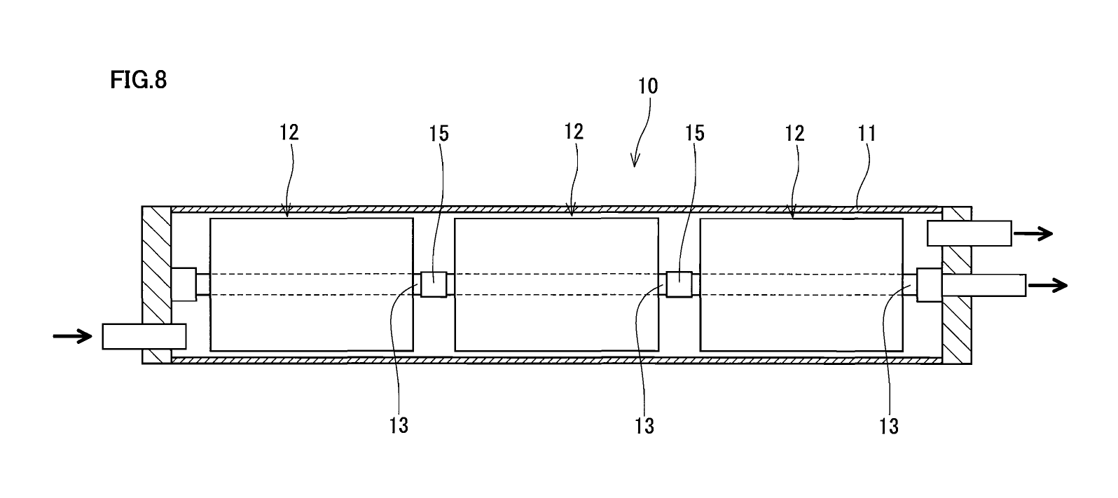

### DESCRIPTION OF EMBODIMENTS

Hereinafter, embodiments of the present invention will be described with reference to the drawings. The following description relates to examples of the present invention, and the present invention is not limited by the examples.

### First Embodiment

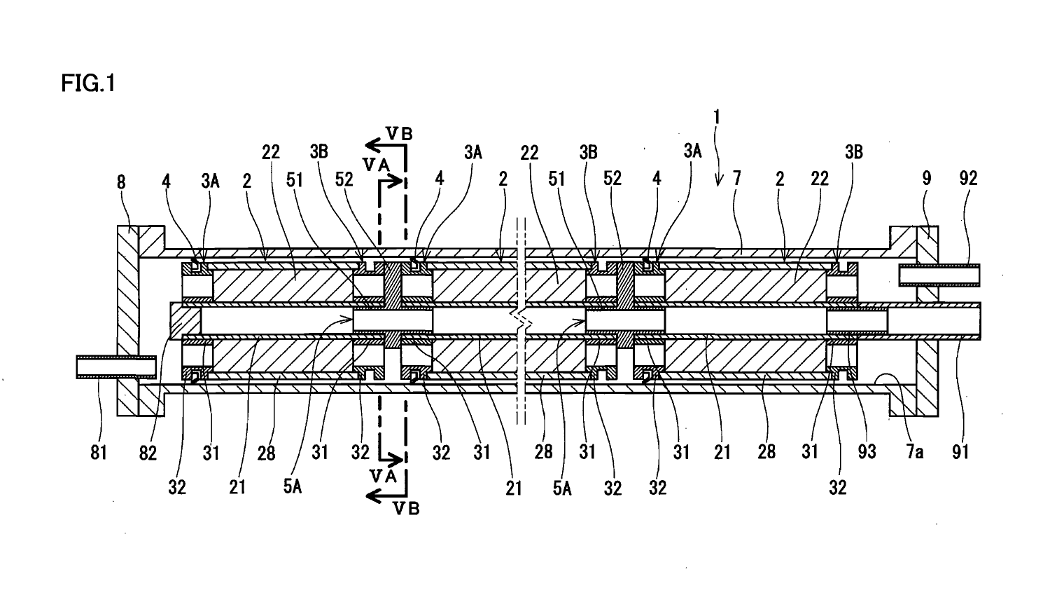

A separation membrane module 1 according to a first embodiment of the present invention is shown in FIG. 1. The separation membrane module 1 includes: a tubular pressure container 7 called a vessel; a plurality of (e.g., three to eight) separation membrane elements 2 loaded in the pressure container 7 so as to be aligned in the axial direction of the pressure container 7; and coupling members 5A coupling together the separation membrane elements 2 adjacent to each other.

Disc-shaped caps 8 and 9 are attached to both ends of the pressure container 7. In the cap 8 on one side (left side in FIG. 1), a feed tube 81 for feeding a raw liquid into the pressure container 7 is provided apart from the center of the cap 8. In the cap 9 on the other side (right side in FIG. 1), a first discharge tube 91 for drawing a permeate liquid produced from the filteration of the raw liquid by separation membranes 23 described later is provided at the center of the cap 9, and a second discharge tube 92 for drawing the concentrated raw liquid is provided apart from the center. That is, a flow of the raw liquid from the cap 8 on the one side to the cap 9 on the other side is formed in the pressure container 7. The feed tube 81 and the second discharge tube 92 may be provided in the pressure container 7.

In the present embodiment, spiral reverse osmosis membrane elements are used as the separation membrane elements 2. However, for example, the separation membrane elements 2 may be spiral ultrafiltration membrane elements or may be other types of cylindrical elements.

Each separation membrane element 2 has a central tube 21 functioning as a water collecting tube, a layered body 22 wound around the central tube 21, a pair of end members 3A and 3B fixed to both end portions of the central tube 21 so as to sandwich the layered body 22; and an outer covering material 28 covering the layered body 22. The pair of end members 3A and 3B also serves to prevent the layered body 22 from extending telescopically.

In the present embodiment, a sealing member 4 is attached to the upstream-side end member 3A of the pair of the end members 3A and 3B, and the sealing member 4 is a packing having an approximately U-shaped cross-section and configured to seal a gap between the separation membrane element 2 and the inner peripheral face of the pressure container 7 by means of a pressure applied by the raw liquid from the upstream side. However, the sealing member 4 is not limited to the packing having an approximately U-shaped cross-section, and may have any shape as long as the sealing member 4 can seal the gap between the separation membrane element 2 and the inner peripheral face of the pressure container 7.

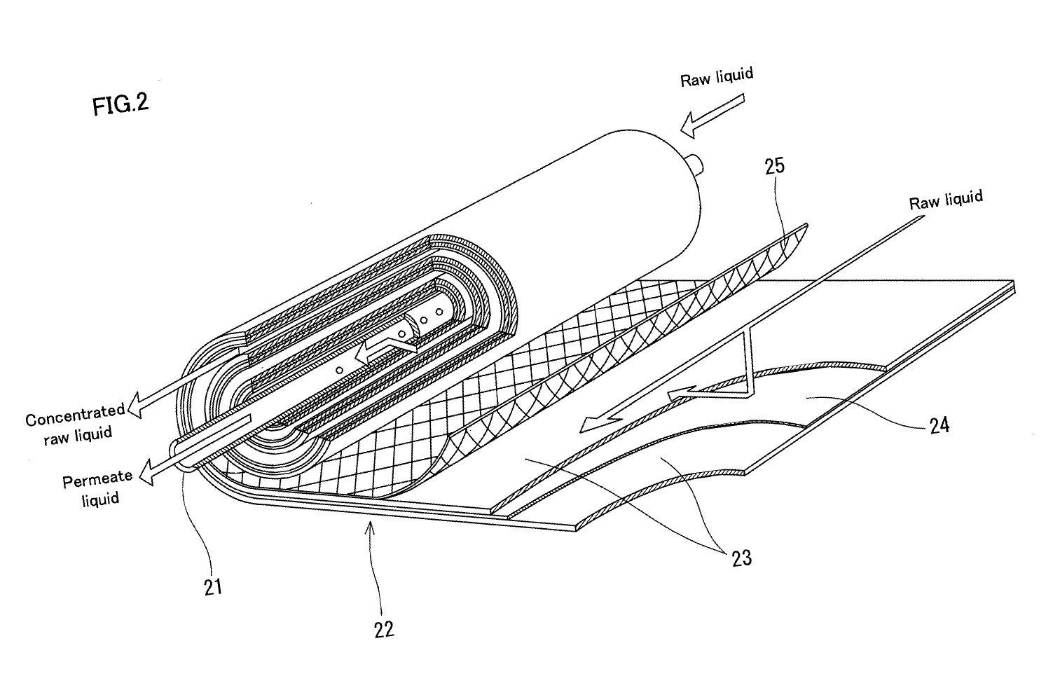

The central tube 21 is provided with a plurality of introduction holes for allowing the permeate liquid to flow into the central tube 21 (see FIG. 2). A hollow axial portion 51 of the coupling member 5A, which will be described later, extends between and connects the central tubes 21 of the separation membrane elements 1 adjacent to each other, and forms a continuous flow path for flowing the permeate liquid. A plug 82 is attached to the central tube 21 of the separation membrane element 2 located at the most upstream position, and the central tube 21 of the separation membrane element 2 located at the most downstream position is coupled to the first discharge tube 91 by a coupler 93.

As shown in FIG. 2, the layered body 22 has a shape of a rectangle, and is wound in a direction from one side of the rectangle to the opposite side. The layered body 22 includes: a membrane leaf composed of a permeate-side flow path material 24 and separation membranes 23 placed on both faces of the permeate-side flow path material 24; and a feed-side flow path material 25. The membrane leaf has a configuration in which the separation membranes 23 are joined together at their respective three sides so that the membrane leaf has a shape of a sack having an opening at one side. The opening communicates with the introduction holes of the central tube 21. The permeate-side flow path material 24 is, for example, a net made of a resin, and forms a flow path for flowing the permeate liquid between the separation membranes 23 joined together. The feed-side flow path material 25 is, for example, a net made of a resin (a net whose meshes are larger than those of the permeate-side flow path material 24), and forms a flow path for flowing the raw liquid between wound layers of the membrane leaf.

Examples of the separation membranes 23 include: composite reverse osmosis membranes in which a polyamide-based skin layer is provided on a support made of a non-woven fabric or of a polysulfone porous membrane; polyvinyl alcohol-based separation membranes excellent in permeability; and sulfonated polyethersulfone-based separation membranes suitable as nanofiltration membranes.

Referring back to FIG. 1, the pair of end members 3A and 3B is fixed to the central tube 21 in such a manner that the end faces thereof are located in the same plane. In addition, it is preferable that the paired end members 3A and 3B have the same shape, and be disposed facing in opposite directions to each other. Depending on practical utility, however, different shapes of end members may be used as the paired end members 3A and 3B, respectively. Specifically, each of the end members 3A and 3B has an inner tubular portion 31 fitted on the outer side of an end portion of the central tube 21, and has an outer tubular portion 32 concentric with the inner tubular portion 31 and surrounding the inner tubular portion 31 at a distance from the inner tubular portion 31.

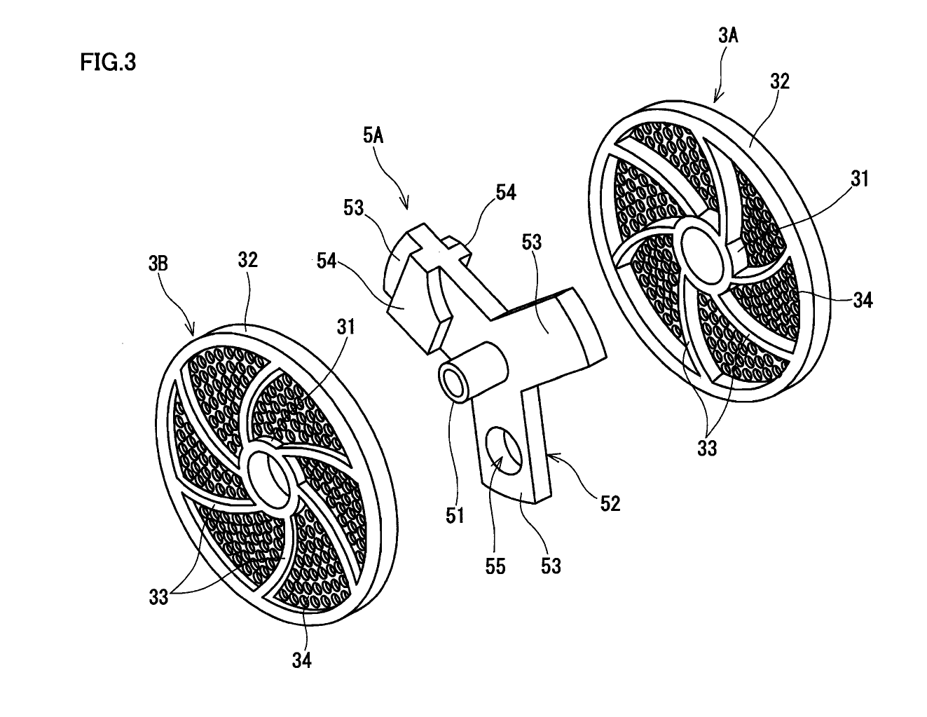

As shown in FIG. 3, the inner tubular portion 31 and the outer tubular portion 32 are connected together by a plurality of (in the example of the figure, six) ribs 33 (omitted from FIG. 1) that are arranged radially. Thin plates 34 (omitted from FIG. 1) are disposed between the ribs 33, and are each provided with a plurality of through holes extending through the end member 3A or 3B so as to allow the raw liquid to flow through the end member. The thin plates 34 need not necessarily be disposed, and spaces between the ribs 33 serve as through openings extending through the end member 3A or 3B so as to allow the raw liquid to flow through the end member.

In the present embodiment, the height of each rib 33 (the size in the axial direction of the central tube 21) is equal to the axial lengths of the inner tubular portion 31 and the outer tubular portion 32, and both end faces of each rib 33 are located in the same plane as both end faces of the inner tubular portion 31 and of the outer tubular portion 32. In addition, each rib 33 is curved in such a manner that the ribs 33 present a counterclockwise vortex pattern when viewed from the inside of the separation membrane element 2. As described above, the paired end members 3A and 3B are disposed facing in opposite directions to each together. Therefore, when the end members 3A and 3B are viewed from the upstream side, the ribs 33 of the end member 3B on the downstream side present a counterclockwise vortex pattern, and the ribs 33 of the end member 3A on the upstream side present a clockwise vortex pattern. The ribs 33 need not necessarily present a vortex pattern, and each rib 33 may extend straight in a radial direction.

As shown in FIG. 1, the outer peripheral face of the outer tubular portion 32 may have formed therein a groove extending in the peripheral direction so as to hold the sealing member 4. Furthermore, a stepped portion for holding the outer covering material 28 may be formed in the outer tubular portion 32. In addition, a groove portion for flowing the raw liquid is preferably provided in the end face of the outer tubular portion 32 that contacts a plate portion 52 described later. This groove portion may be provided in the wall face of the plate portion 52.

The end members 3A and 3B can each be produced by molding a plastic resin using a metal mold. Examples of the plastic resin include ABS resins, polyolefin resins such as polyethylene (PE) and polypropylene (PP), modified polyphenylene ether (PPE) resins, vinyl chloride (VC) resins, and polysulfone (PSU) resins.

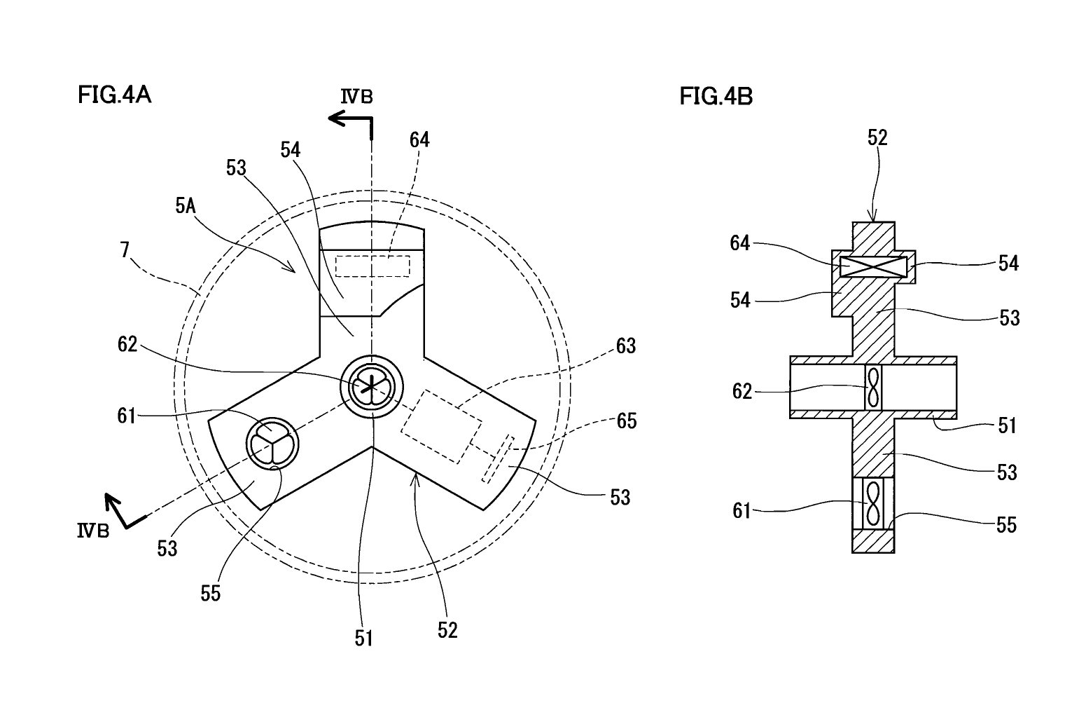

The coupling member 5A couples together the separation membrane elements 2 adjacent to each other by being fitted to the central tubes 21. Specifically, as shown in FIG. 4A and FIG. 4B, the coupling member 5A has: an axial portion 51 both end portions of which are fitted in the central tubes 21; and a plate portion 52 extending from a central portion of the axial portion 51 and interposed between the end members 3A and 3B. In the present embodiment, the axial portion 51 and the plate portion 52 are integrally formed of a resin. However, these portions may be separately molded, and then joined by an adhesive or by welding.

The method for integrally forming the axial portion 51 and extension portions 53 is not particularly limited. Examples of the method include injection molding, extrusion molding, insert molding, cast molding, and vacuum cast molding. In addition, examples of the resin used include ABS resins, polyolefin resins such as polyethylene (PE) and polypropylene (PP), modified polyphenylene ether (PPE) resins, vinyl chloride (VC) resins, and polysulfone (PSU) resins. Among these resins, modified PPE resins excellent in pressure resistance are particularly preferably used.

The axial portion 51 has a shape of a tube having a uniform thickness. Although not shown in the drawings, sealing members (e.g., O-rings) for sealing a gap between the outer peripheral face of the axial portion 51 and the inner peripheral face of the central tube 21 are attached to both end portions of the axial portion 51. One sealing member or a plurality of sealing members may be attached to each end portion. The central tube 21 need not necessarily have a constant diameter over the entire length thereof. An increased-diameter portion having an increased inner diameter may be provided in the end portion of the central tube 21, and the end portion of the axial portion 51 may be fitted into the increased-diameter portion.

In the present embodiment, both principal faces of the plate portion 52 that respectively face the end members 3A and 3B contact the end faces of the end members 3A and 3B. However, both principal faces of the plate portion 52 need not necessarily contact the end faces of the end members 3A and 3B. For example, tubular portions projecting from both principal faces of the plate portion 52 may be formed around the axial portion 51, and the end faces of the tubular portions may contact the end faces of the end members 3A and 3B so that both principal faces of the plate portion 52 are spaced from the end faces of the end members 3A and 3B.

The plate portion 52 has a plurality of (in the example of the figure, three) extension portions 53 extending radially outward from the axial portion 51. Each extension portion 53 has a width sufficiently larger than its thickness. Preferably, at least the width of the root portion of the extension portion 53 is larger than the outer diameter of the axial portion 51. In this case, the root portions of the extension portions 53 are continuous with each other, and a seamless ring portion can be formed around the axial portion 51. Accordingly, for example, electrical wiring can be installed in the ring portion.

Furthermore, in the present embodiment, the coupling member 5A is configured so that the coupling member 5A is engaged with the end members 3A and 3B located on both sides of the coupling member 5A, and is thus restrained from rotating. Specifically, on each of both principal faces of the plate portion 52, a projecting portion 54 projecting from the principal face and engaged with the end member 3A (or 3B) is provided. In the present embodiment, both of the projecting portions 54 are provided in the same extension portion 53. The projecting portion of the present invention only needs to be supported by the end member sufficiently to prevent the rotation of the plate portion (coupling member), but may be configured to be coupleable to the end member.

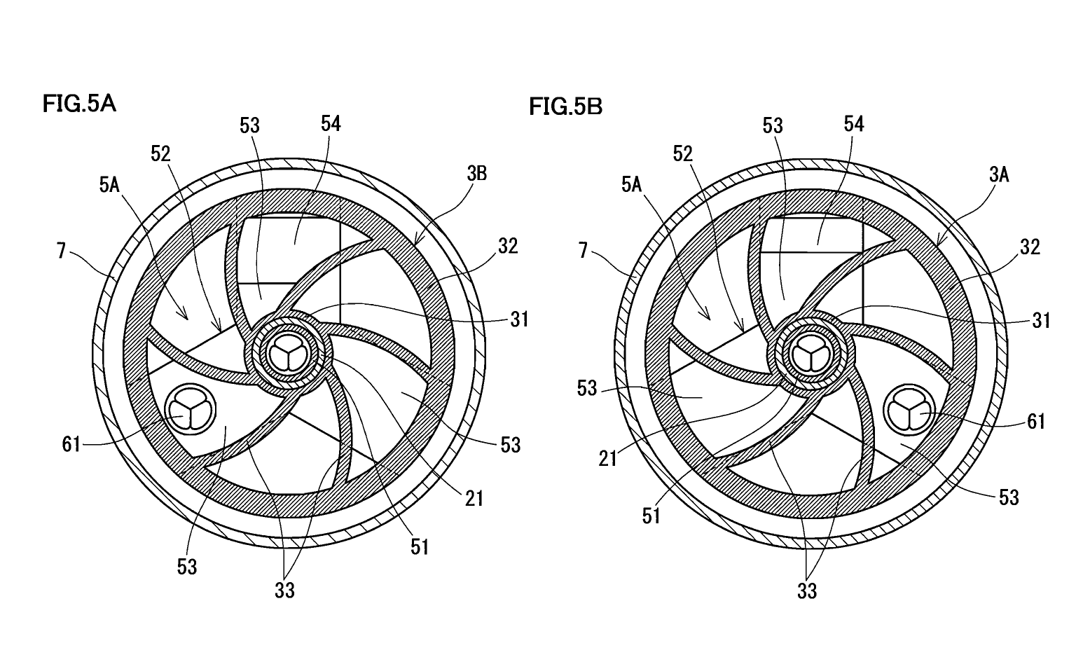

As shown in FIG. 5A and FIG. 5B, each projecting portion 54 is fitted between the ribs 33 in the vicinity of the inner peripheral face of the outer tubular portion 32 of the end member 3A (or 3B). In the present embodiment, each projecting portion 54 is formed in such a shape that the projecting portion 54 contacts both of the ribs 33 adjacent to each other, and is held between the adjacent ribs 33. However, each projecting portion 54 need not necessarily contact both of the adjacent ribs 33, and may be loosely fitted between the ribs 33.

The projecting portions 54 may be formed integrally with the plate portion 52. Alternatively, the projecting portions 54 may be molded separately from the plate portion 52, and then joined to the plate portion 52 by an adhesive or by welding.

Referring back to FIG. 4A and FIG. 4B, a power-supply device 64 is enclosed in the extension portion 53 provided with the projecting portions 54 (the extension portion 53 located on the upper side in FIG. 4A) at a position corresponding to the projecting portions 54. Specifically, the power-supply device 64 lies between the projecting portions 54. The power-supply device 64 supplies power to a first flow rate sensor 61 and a second flow rate sensor 62 via a circuit board 63. A battery or a generator can be used as the power-supply device 64. Alternatively, connection to an AC power supply or wireless power transmission can be used. Especially, a battery, which can easily be used, is preferably used.

The first flow rate sensor 61 is mounted in another one of the extension portions 53 (the extension portion 53 located on the left lower side in FIG. 4A, which may be referred to as an “extension portion for sensor 53” hereinafter). The second flow rate sensor 62 is mounted in the axial portion 51. The first flow rate sensor 61 is intended to detect the flow rate of the raw liquid sent from the upstream-side separation membrane element 2 into the downstream-side separation membrane element 2, and the second flow rate sensor 62 is intended to detect the flow rate of the permeate liquid sent from the upstream-side separation membrane element 2 into the downstream-side separation membrane element 2.

Specifically, the extension portion for sensor 53 is provided with a through hole 55 extending through the extension portion 53 in the axial direction of the axial portion 51, and the first flow rate sensor 61 is installed in the through hole 55. On the other hand, the second flow rate sensor 62 is installed in the axial portion 51.

Various types of flowmeters such as an electromagnetic flowmeter and an impeller-type flowmeter can be used as the first flow rate sensor 61 and the second flow rate sensor. An impeller-type flowmeter having a simple configuration is preferably used.

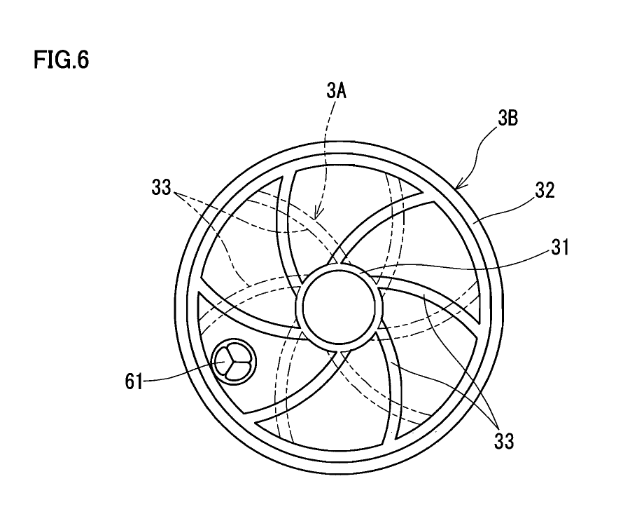

In the present embodiment, as shown in FIG. 5A and FIG. 5B, the positional relationship between the end members 3A and 3B sandwiching the plate portion 52 via the projecting portions 54 described above is determined so that an area of overlap between the extension portion for sensor 53 and one of the spaces between the ribs 33 in one end member is maximized, and that an area of overlap between the extension portion for sensor 53 and one of the spaces between the ribs 33 in the other end member is maximized. The through hole 55 is located in an overlapping region between the areas. In other words, as shown in FIG. 6, the first flow rate sensor 61 is disposed in a region of the plate portion 52 sandwiched by the end members 3A and 3B, the region facing both the space between the ribs 33 in the end member 3A and the space between the ribs 33 in the end member 3B.

In the present embodiment, only one first flow rate sensor 61 is provided. However, a plurality of first flow rate sensors 61 having different sizes are preferably provided. With such a configuration, errors caused by the interindividual variability of flow rate sensors can be compensated.

An antenna 65 for transmitting, for example, detection signals generated by the first flow rate sensor 61 and the second flow rate sensor 62 is held in an end portion of the remaining extension portion 53 (the extension portion 53 located on the lower right side in FIG. 4A). Here, the “end portion” means a region extending from an end face of the extension portion 53 and corresponding to about ⅓ of the entire length of the extension portion 53 from the axial portion 51. In the present embodiment, the antenna 65 is enclosed in the extension portion 53.

The antenna 65 extends in the width direction of the extension portion 53 in which the antenna 65 is enclosed. The length of the antenna 65 depends on the frequency of a radio wave used for wireless communication. Examples of the system of wireless communication include the WiFi system, the ZigBee system, the Bluetooth system, and the IrDA system. Among these systems, the ZigBee system is particularly preferable from the standpoint of managing a number of sensors for individual evaluations of the separation membrane elements 2 and from the standpoint of saving power consumption. When a primary data-gathering device for collecting information from the antenna 65 is placed outside the pressure container 7, and is linked to a central control center by wired or wireless connection, a large-scale sensor network can be constructed.

Furthermore, in the present embodiment, the circuit board 63 is also enclosed in the extension portion 53 in which the antenna 65 is enclosed, and the circuit board 63 is connected to the power-supply device 64, the first flow rate sensor 61, the second flow rate sensor 62, and the antenna 65. In other words, the antenna 65 is connected to the first flow rate sensor 61 and the second flow rate sensor 62 via the circuit board 63. For example, a wireless communication circuit for wireless communication using the antenna 65, and a power control circuit for controlling power supply from the power-supply device 64 to the first flow rate sensor 61 and the second flow rate sensor 62, are formed on the circuit board 63. The circuit board 63 may extend up to the region immediately below the antenna 65 so that the antenna 65 is mounted directly on the circuit board 63. Alternatively, the circuit board 63 may be located radially inward of the antenna 65, and connected to the antenna 65 by electrical wiring.

Examples of the method for enclosing an electric component in the extension portion 53 as described above include a method in which the extension portion 53 is divided into two pieces in the axial direction of the axial portion 51, the electric component is mounted on the divided face of one of the pieces, and then the two pieces are joined together.

In the separation membrane module 1 of the present embodiment having been described above, the coupling member 5A in which the first flow rate sensor 61 and the second flow rate sensor 62 are mounted is restricted from rotating relative to the separation membrane elements 2. Therefore, stable measurement using the sensors can be performed.

Furthermore, in the present embodiment, the power-supply device 64 is enclosed in the plate portion 52 at a position corresponding to the projecting portions 54. The power-supply device 64 generally has a relatively large thickness. Disposing such a power-supply device 64 at a position corresponding to the projecting portions 54 can result in reduction of the thickness of the plate portion 52.

Furthermore, when the projecting portion 54 is provided on each of both principal faces of the plate portion 52 as in the present embodiment, a required projection height of the projecting portion 54 for enclosing the power-supply device 64 can be reduced compared to when the projecting portion 54 is provided on one of the principal faces of the plate portion 52.

In the case where the plate portion 52 is pressed by the end members 3A and 3B, and where a sensor is disposed at a position at which the plate portion 52 constacts the end members 3A and 3B, there is a risk that the sensor malfunctions or is broken due to a compression stress applied to the sensor. In particular, such defects are highly likely to occur at positions at which the ribs 33 of one end member and the ribs 33 of the other end member intersect each other as shown FIG. 6. However, in the present embodiment, the first flow rate sensor 61 is disposed in a region of the plate portion 52 sandwiched by the end members 3A and 3B, the region facing both a space between the ribs 33 in the end member 3A and a space between the ribs 33 in the end member 3b. Therefore, occurrence of the defects as described above can be prevented. This effect can be obtained as long as the first flow rate sensor 61 is disposed in a region of the plate portion 52 that faces a space between the ribs 33 in at least one of the end members 3A and 3B.

In the present embodiment, the first flow rate sensor 61 and the second flow rate sensor 62 are used. However, sensors used in the present invention are not limited thereto. Any sensor that is capable of detecting the characteristics of at least one of the raw liquid and the permeate liquid may be used. For example, a sensor used in the present invention may be a pressure sensor, a temperature sensor, a conductivity sensor, or the like.

In the present embodiment, the projecting portion 54 is provided on each of both principal faces of the plate portion 52. However, the projecting portion 54 may be provided on at least one of both principal faces of the plate portion 52 so that the coupling member 5A is engaged with at least one of the end members 3A and 3B located on both sides of the coupling member 5A.

### Second Embodiment

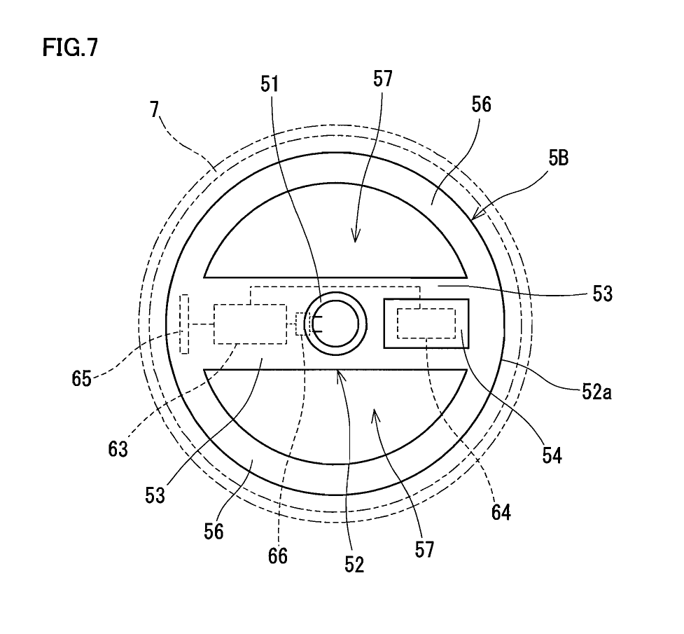

Next, a separation membrane module according to a second embodiment of the present invention will be described. The separation membrane module of the present embodiment is different from the separation membrane module 1 of the first embodiment only in that a coupling member 5B shown in FIG. 7 is used instead of the coupling member 5A. Therefore, only the coupling member 5B will be described hereinafter. In FIG. 7, the same components as those described in the first embodiment are denoted by the same reference characters.

In the present embodiment, the plate portion 52 has two extension portions 53 extending outward in opposite radial directions from the axial portion 51. Furthermore, the plate portion 52 is provided with a bridge portion 56 having an arc shape and forming a bridge between the end portions of the extension portions 53. The end faces of the extension portions 53 and the outer side face of the bridge portion 56 form a cylindrical outer peripheral face of the coupling member 5B. In addition, the inner side face of the bridge portion 56 and the side faces of the extension portions 53 form openings 57 extending through the coupling member 5B in the axial direction of the axial portion 51.

The antenna 65 is held in the end portion of one of the extension portions 53 (the extension portion 53 located on the left in FIG. 7). As in the first embodiment, the antenna 65 is enclosed in the extension portion 53. In addition, the circuit board 63 is enclosed in the extension portion 53.

A pair of projecting portions 54 (only one of the projecting portions 54 is shown in FIG. 7) is provided in the other extension portion 53 (the extension portion 53 located on the right in FIG. 7). The projecting portions 54 project from the extension portion 53 so as to be fitted between the ribs 33 of the end members 3A and 3B, and thus are engaged with the end members 3A and 3B. In addition, the power-supply device 64 is enclosed in the extension portion 53 at a position corresponding to the projecting portions 54.

In the present embodiment, a conductivity sensor 66 for detecting the electric conductivity of the permeate liquid is mounted in the coupling member 5B. The conductivity sensor 66 has a main body enclosed in the coupling member 5B, and a pair of electrodes projecting from the main body into the axial portion 51. Power is supplied from the power-supply device 64 to the conductivity sensor 66 via the circuit board 63, and a voltage is thus applied between the pair of electrodes. The conductivity sensor 66 is not limited to an electrode-type sensor, and an electromagnetic sensor can also be used. However, an electrode-type conductivity sensor is preferably used from the standpoint of the measurement range of electric conductivity in the intended use.

Also when the coupling member 5B having the above configuration is used, the same effect as in the first embodiment can be obtained.

### Other Embodiments

In the first and second embodiments, the antenna 65 is enclosed in the extension portion 53. However, in the case where, for example, the antenna 65 is a waterproofed antenna, a part or all of the antenna 65 may be exposed from the extension portion 53.

### DESCRIPTION OF THE REFERENCE CHARACTERS

1 Separation membrane module
2 Separation membrane element
21 Central tube
22 Layered body
23 Separation membrane
24 Permeate-side flow path material
25 Feed-side flow path material
3A, 3B End member
31 Inner tubular portion
32 Outer tubular portion
33 Rib
5A, 5B Coupling member
51 Axial portion
52 Plate portion
53 Extension portion
54 Projecting portion
61 First flow rate sensor
62 Second flow rate sensor
65 Antenna
66 Conductivity sensor
7 Pressure container

1. A separation membrane module comprising:
a pressure container having a tubular shape;
a plurality of separation membrane elements loaded in the pressure container so as to be aligned in an axial direction of the pressure container, each of the separation membrane elements comprising a central tube and a pair of end members fixed to both end portions of the central tube;
a coupling member coupling together the separation membrane elements adjacent to each other by being fitted to the central tubes, the coupling member being configured to be engaged with at least one of the end members located on both sides of the coupling member; and
a sensor mounted in the coupling member.

2. The separation membrane module according to claim 1, wherein
the coupling member comprises: an axial portion being hollow and having both end portions fitted in the central tubes; and a plate portion interposed between the end members, and
a projecting portion is provided on at least one of both principal faces of the plate portion that face the end members, the projecting portion projecting from the principal face and being engaged with the end member.

3. The separation membrane module according to claim 2, wherein
the end member has: an inner tubular portion fitted to the central tube; an outer tubular portion surrounding the inner tubular portion at a distance from the inner tubular portion; and a plurality of ribs coupling the inner tubular portion and the outer tubular portion together, and
the projecting portion is disposed between the ribs.

4. The separation membrane module according to claim 2, wherein the projecting portion is provided on each of both principal faces of the plate portion.

5. The separation membrane module according to claim 3, wherein the sensor is disposed in a region of the plate portion, the region facing a space between the ribs in at least one of the end members.

6. The separation membrane module according to claim 2, wherein a power-supply device for supplying power to the sensor is enclosed in the plate portion at a position corresponding to the projecting portion.

7. The separation membrane module according to claim 2, further comprising an antenna held in the plate portion and connected to the sensor.

8. The separation membrane module according to claim 7, wherein
the plate portion has a plurality of extension portions extending radially outward from the axial portion, and
the antenna is held in an end portion of the extension portion.

9. The separation membrane module according to claim 1, wherein the separation membrane element is a spiral separation membrane element comprising the central tube and a layered body wound around the central tube, the layered body comprising a separation membrane and a flow path material.

10. A coupling member for coupling together separation membrane elements each including a central tube and a pair of end members fixed to both end portions of the central tube, the coupling member comprising:
an axial portion being hollow and having both end portions configured to be fitted in the central tubes;
a plate portion configured to be interposed between the end members; and
a projecting portion projecting from the plate portion and configured to be engaged with the end member.
